(19) United States
(12) Patent Application Publication
(10) Pub. No.: US 2025/0210717 A1
(43) Pub. Date: Jun. 26, 2025

(54) ELECTROLYTE FOR LITHIUM METAL BATTERY, AND LITHIUM METAL BATTERY INCLUDING THE SAME

(71) Applicants: Hyundai Motor Company, Seoul (KR); Kia Corporation, Seoul (KR)

(72) Inventors: Jiho Lim, Seoul (KR); Ji Yong Lee, Seoul (KR); WonKeun Kim, Seoul (KR); Eunji Kwon, Seoul (KR); Yeonjong Oh, Seoul (KR); Kyuju Kwak, Seoul (KR); Dong Hyun Lee, Seoul (KR); Sangsu Lee, Seoul (KR); Kyoung Han Ryu, Seoul (KR); Samuel Seo, Seoul (KR)

(21) Appl. No.: 18/771,144

(22) Filed: Jul. 12, 2024

(30) Foreign Application Priority Data
Dec. 20, 2023 (KR) 10-2023-0187477

(51) Int. Cl. H01M 10/0568; C01B 21/093; H01M 10/052; H01M 10/0567; H01M 10/0569; H01M 10/42

(52) U.S. Cl. CPC H01M 10/0568; C01B 21/093; H01M 10/052; H01M 10/0567; H01M 10/0569; H01M 10/4235; C01P 2002/82; C01P 2002/86; C01P 2004/03; C01P 2006/40; H01M 2300/0034

(57) ABSTRACT

Described are an electrolyte for a lithium metal battery, and a lithium metal battery including the same, the electrolyte containing a first lithium salt containing a fluorosulfonyl group, a second lithium salt containing a trifluoromethanesulfonyl group, and a solvent containing a fluorosulfonyl group, wherein a molar ratio of the first lithium salt to the second lithium salt is 0.65:0.35 to 0.75:0.25.

### CROSS-REFERENCE TO RELATED APPLICATION

This application claims the benefit of Korean Patent Application No. 10-2023-0187477 filed in the Korean Intellectual Property Office on Dec. 20, 2023, the entire contents of which are incorporated herein by reference.

### BACKGROUND

### Technical Field

The present exemplary embodiments relate to an electrolyte for a lithium metal battery, and a lithium metal battery including the same.

### Background

Lithium secondary batteries are used as power sources for driving portable electronic devices such as video cameras, mobile phones, and notebook computers. Rechargeable lithium secondary batteries have more than three times the energy density per unit weight than known lead-acid batteries, nickel-cadmium batteries, nickel metal hydride batteries, and nickel-zinc batteries, and may be charged at a high speed.

In general, a lithium secondary battery is manufactured by using materials capable of reversibly intercalating and deintercalating lithium ions as a cathode active material and an anode active material and filling an electrolyte between a cathode including the cathode active material and an anode including the anode active material. Among the lithium secondary batteries, currently commercialized lithium-ion batteries have the disadvantage of having a short driving range per charge due to limitations in energy density. In order to develop an electric vehicle having a driving range comparable to that of an internal combustion engine vehicle, there is a need to develop next-generation batteries having a higher energy density than existing lithium-ion batteries, and among secondary batteries that meet this requirement, lithium metal batteries are receiving a lot of attention. A lithium metal battery is a secondary battery that uses a lithium metal as an anode and may be classified into a lithium-metal oxide battery, a lithium-sulfur battery, a lithium-air battery, and the like depending on the type of cathode.

Currently, batteries using salts or solvents containing a fluorosulfonyl group in organic electrolytes for lithium secondary batteries have been developed. Salts such as lithium bis(fluorosulfonyl)imide (LiFSI) and lithium bis(trifluoromethanesulfonylimide (LiTFSI) are frequently used in existing lithium ion batteries (LIBs) or lithium metal batteries (LMBs). Carbonate-based and ether-based solvents have been mainly developed as solvents.

Recently, an electrolyte using N,N-dimethylsulfamoyl fluoride (FSA), which has a structure similar to a salt, as a solvent has been reported. Using an electrolyte with fluorosulfonyl groups in both a salt and a solvent may maximize deposition-stripping reversibility of lithium and may improve durability of a lithium metal battery.

However, the existing electrolyte has the problem of deterioration of battery durability due to depletion of the LiFSI salt according to a cycle in an acceleration evaluation at 1 C and oxidative degradation of the FSA solvent at a terminal. Therefore, studies on a complex salt electrolyte system that may overcome these disadvantages were conducted, and the present disclosure was completed.

### SUMMARY OF THE INVENTION

The present disclosure has been made in an effect to provide an electrolyte for a lithium metal battery having advantages of improving battery durability and ionic conductivity, and a lithium metal battery including the same.

An exemplary embodiment of the present disclosure provides an electrolyte for a lithium metal battery, the electrolyte containing: a first lithium salt containing a fluorosulfonyl group represented by Chemical Formula 1; a second lithium salt containing a trifluoromethanesulfonyl group represented by Chemical Formula 2; and a solvent containing a fluorosulfonyl group represented by Chemical Formula 1, wherein a molar ratio of the first lithium salt to the second lithium salt is 0.65:0.35 to 0.75:0.25:

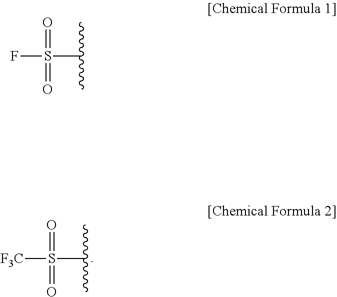 [SMILES: *S(=O)(=O)F ; *S(=O)(=O)C(F)(F)F]

In certain aspects, the molar ratio of the first lithium salt to the second lithium salt may be 0.7:0.3. In certain aspects, a molar ratio of the solvent to a complex salt comprising the first lithium salt and the second lithium salt may be 1:1 to 1:10. For example, in one aspect, the molar ratio of the solvent to the complex salt comprising the first lithium salt and the second lithium salt is 1:3. Another exemplary embodiment of the present disclosure provides a lithium metal battery including: a cathode; an anode; and an electrolyte located between the cathode and the anode, wherein the electrolyte is the electrolyte for a lithium metal battery described above.

In some embodiments, the first lithium salt comprises a first lithium salt represented by Chemical Formula 3, the second lithium salt comprises a second lithium salt represented by Chemical Formula 4, the solvent comprises a solvent represented by Chemical Formula 5, and a molar ratio of the first lithium salt to the second lithium salt is 0.65:0.35 to 0.75:0.25,

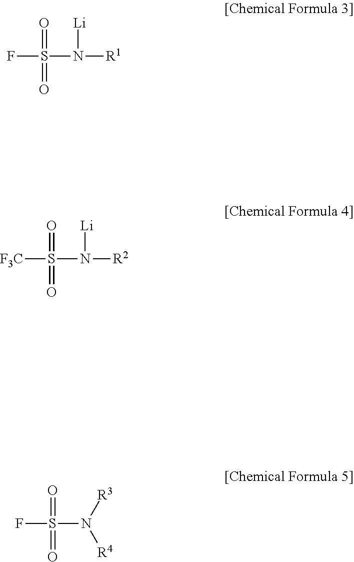

wherein R¹ and R² are substituted with one functional group selected from the group consisting of

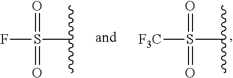 [SMILES: *S(=O)(=O)F ; *S(=O)(=O)C(F)(F)F]

and
R³ and R⁴ are each independently comprise hydrogen or an unsubstituted C1-10 alkyl group.

In some embodiments, the first lithium salt containing a fluorosulfonyl group and the solvent containing a fluorosulfonyl group do not contain a trifluoromethanesulfonyl group.

In some embodiments, the second lithium salt containing a trifluoromethanesulfonyl group does not contain a fluorosulfonyl group.

In some embodiments, a molar ratio of the solvent to a complex salt comprising the first lithium salt and the second lithium salt is 1:1 to 1:10. For example, the molar ratio of the solvent to the complex salt comprising the first lithium salt and the second lithium salt is 1:3.

In some embodiments, the first lithium salt is a lithium salt represented by Chemical Formula 6:

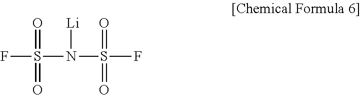

In some embodiments, the second lithium salt is a lithium salt represented by Chemical Formula 7:

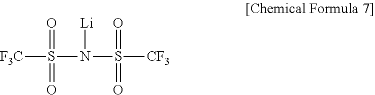

In some embodiments, the solvent is a solvent represented by Chemical Formula 8:

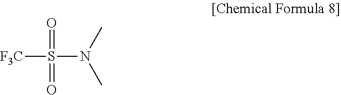

In some embodiments, the electrolyte further comprises one or more additives e.g. selected from lithium nitrate (LiNO3), vinylene carbonate (VC), fluoroethylene carbonate (FEC), difluoroethylene carbonate, chloroethylene carbonate, dichloroethylene carbonate, bromoethylene carbonate, dibromoethylene carbonate, nitroethylene carbonate, cyanoethylene carbonate, vinylethylene carbonate (VEC), adiponitrile (AN), succinonitrile (SN), 1,3,6-hexane tricyanide (HTCN), propene sultone (PST), propane sultone (PS), lithium tetrafluoroborate (LiBF4), lithium difluorophosphate (LiPO2F2), and 2-fluorobiphenyl (2-FBP).

In some embodiments, the lithium nitrate is contained in an amount of 0.01 to 0.1 wt % with respect to a total weight of the electrolyte for a lithium metal battery.

According to the present exemplary embodiment, the electrolyte for a lithium metal battery contains the first lithium salt containing a fluorosulfonyl group, the second lithium salt containing a trifluoromethanesulfonyl group, and the solvent containing a fluorosulfonyl group in specific molar ratios, such that the electrolyte for a lithium metal battery may have high ionic conductivity.

In addition, the lithium metal battery manufactured according to the present exemplary embodiment may suppress side reactions between the lithium metal and the electrolyte, may increase the reversibility of the deposition-stripping reaction of the lithium metal due to induction of dense deposition of lithium, and may suppress the growth of dendritic lithium, such that the battery may have improved durability and excellent performance.

When charged to 4.25 V and then discharged to 2.5 V at 25° C. under 1 C-1 C conditions in one cycle, the lithium metal battery has a capacity retention of 70% or more after 120 cycles.

When charged to 4.25 V and then discharged to 2.5 V at 25° C. under 1/3 C-1/3 C conditions in one cycle, a molar ratio of the total lithium salts to the solvent in the lithium metal battery is 1:1 to 1:10 after 50 cycles.

In the lithium metal battery, a lithium deposition layer disposed on the anode may have a thickness of 40 μm or less.

Also disclosed is a battery comprising the electrolyte and the lithium metal battery.

As discussed, the method and system suitably include use of a controller or processer.

### BRIEF DESCRIPTION OF THE DRAWINGS

FIG. 1 is a graph showing the results of measuring Raman spectra in a range of 670 cm⁻¹ to 800 cm⁻¹ for electrolytes of Examples and Comparative Examples.

FIG. 2 is a graph showing the results of measuring Raman spectra in a range of 710 cm⁻¹ to 740 cm⁻¹ for electrolytes of Examples and Comparative Examples.

FIG. 3 is a graph showing the results of measuring capacity retentions according to the number of cycles when charging and discharging are performed under 1/3 C-1/3 C conditions in Cu-NMCs (anodeless cells) including electrolytes of Example 1 and Comparative Example 1, respectively.

FIG. 4 is a graph showing the results of measuring capacity retentions according to the number of cycles when charging and discharging are performed under 1 C-1 C conditions in coil cells including electrolytes of Example 1 and Comparative Examples 1 to 7, respectively.

FIG. 5 is a graph showing the results of measuring capacity retentions according to the number of cycles when charging and discharging are performed under 1 C-1 C conditions in coil cells including electrolytes of Example 1 and Comparative Examples 1 and 8, respectively.

FIG. 6 is a graph obtained by analyzing, by NMR, the amounts of solvent FSA and first lithium salt LiFSI consumed (a unit of mole) in the electrolyte of Comparative Example 1 according to the number of cycles when charging and discharging are performed under 1/3 C-1/3 C conditions.

FIG. 7 is a graph obtained by analyzing, by NMR, the amounts of solvent FSA, first lithium salt LiFSI, and second lithium salt LiTFSI consumed (a unit of mole) in the electrolyte of Example 1 according to the number of cycles when charging and discharging are performed under 1/3 C-1/3 C conditions.

FIG. 8 is an SEM image magnified 1,000 times of a top of a current collector when using the electrolyte of Example 1.

FIG. 9 is an SEM image magnified 2,500 times of the top of the current collector when using the electrolyte of Example 1.

FIG. 10 is an SEM image magnified 1,000 times of a top of a current collector when using the electrolyte of Comparative Example 1.

FIG. 11 is an SEM image magnified 2,500 times of the top of the current collector when using the electrolyte of Comparative Example 1.

FIG. 12 is an SEM image magnified 1,000 times of a side of the current collector when using the electrolyte of Example 1.

FIG. 13 is an SEM image magnified 1,000 times of a side of the current collector when using the electrolyte of Comparative Example 1.

FIG. 14 is a graph obtained by measuring discharge capacity retentions according to a cycle of a coin cell including each of the electrolytes of Example 1 and Comparative Example 1, respectively.

### DETAILED DESCRIPTION OF THE EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Unless defined otherwise, all terms including technical terms and scientific terms used herein have the same meanings as understood by those skilled in the art to which the present disclosure pertains. Terms defined in a generally used dictionary are additionally interpreted as having the meanings matched to the related technical document and the currently disclosed contents, and are not interpreted as ideal or very formal meanings unless otherwise defined.

The terms “first”, “second”, “third”, and the like are used to describe various parts, components, regions, layers, and/or sections, but are not limited thereto. These terms are only used to differentiate a specific part, component, region, layer, or section from another part, component, region, layer, or section. Accordingly, a first part, component, region, layer, or section which will be described hereinafter may be referred to as a second part, component, region, layer, or section without departing from the scope of the present disclosure.

In addition, unless specifically stated, % means mol %, and when a unit is not separately stated, a unit based on mol is omitted.

In the present specification, the term “combination thereof” as described in Markush type expression means a mixture or combination of one or more selected from the group consisting of components described in Markush type expression, and means including one or more selected from the group consisting of the components.

Hereinafter, exemplary embodiments of the present disclosure will be described in detail. However, these exemplary embodiments are provided as examples, and the present disclosure is not limited by these exemplary embodiments and is defined by only the scope of the claims to be described below.

### Electrolyte for Lithium Metal Battery

As described above, when a cycle is performed using a single salt electrolyte, the salt is depleted, which lowers ionic conductivity of a cell, and durability deteriorates due to oxidative degradation of a solvent containing a fluorosulfonyl group.

However, in the present exemplary embodiment, the addition of a lithium salt containing a trifluoromethanesulfonyl group—which degrades more slowly than the lithium salt containing a fluorosulfonyl group—helps overcome the limitations of ionic conductivity performance seen in existing single salt electrolytes. More specifically, these problems may be solved by an electrolyte for a lithium metal battery containing a first lithium salt containing a fluorosulfonyl group represented by the following Chemical Formula 1, a second lithium salt containing a trifluoromethanesulfonyl group represented by the following Chemical Formula 2, and a solvent containing a fluorosulfonyl group represented by the following Chemical Formula 1 in specific molar ratio ranges.

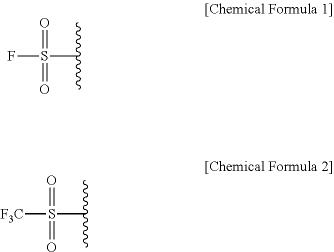 [SMILES: *S(=O)(=O)F ; *S(=O)(=O)C(F)(F)F]

Specifically, the electrolyte for a lithium metal battery according to an exemplary embodiment may have a molar ratio of the first lithium salt to the second lithium salt of 0.65:0.35 to 0.75:0.25, 0.67:0.33 to 0.73:0.27, or 0.69:0.31 to 0.71:0.29. In some embodiments, the molar ratio of the first lithium salt to the second lithium salt is 0.7:0.3.

In this case, a molar ratio of the solvent to a complex salt including the first lithium salt and the second lithium salt may be 1:1 to 1:10, 1:2 to 1:5, or 1:25 to 1:35. In some embodiments, the molar ratio of the solvent to the complex salt comprising the first lithium salt and the second lithium salt is 1:3.

When the molar ratio range is satisfied, electrochemical properties such as ionic conductivity and durability of a lithium metal battery including the electrolyte for a lithium metal battery may be improved as in the present exemplary embodiment.

The first lithium salt may be a lithium salt represented by the following Chemical Formula 3.

The second lithium salt may be a lithium salt represented by the following Chemical Formula 4.

The solvent may be a solvent represented by the following Chemical Formula 5.

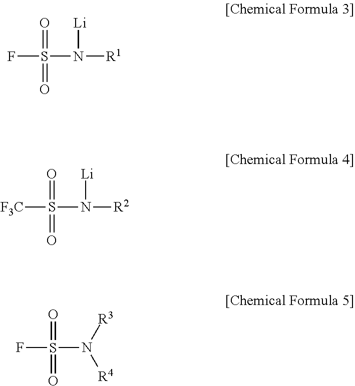

R¹ and R² may be substituted with one functional group selected from the group consisting of

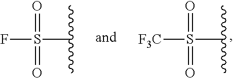 [SMILES: *S(=O)(=O)F ; *S(=O)(=O)C(F)(F)F]

and R³ and R⁴ may be each independently substituted with one functional group selected from the group consisting of hydrogen and an unsubstituted C1-10 alkyl group.

The first lithium salt containing a fluorosulfonyl group and the solvent containing a fluorosulfonyl group may not contain a trifluoromethanesulfonyl group.

The second lithium salt containing a trifluoromethanesulfonyl group may not contain a fluorosulfonyl group. The first lithium salt may be a lithium salt represented by the following Chemical Formula 6.

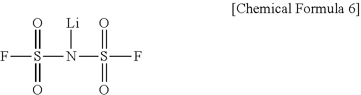

The second lithium salt may be a lithium salt represented by the following Chemical Formula 7.

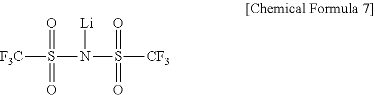

The solvent may be a solvent represented by the following Chemical Formula 8.

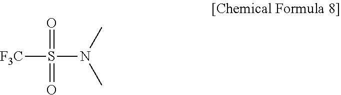

The electrolyte for a lithium metal battery may further contain one or more additives selected from lithium nitrate (LiNO₃), vinylene carbonate (VC), fluoroethylene carbonate (FEC), difluoroethylene carbonate, chloroethylene carbonate, dichloroethylene carbonate, bromoethylene carbonate, dibromoethylene carbonate, nitroethylene carbonate, cyanoethylene carbonate, vinylethylene carbonate (VEC), adiponitrile (AN), succinonitrile (SN), 1,3,6-hexane tricyanide (HTCN), propene sultone (PST), propane sultone (PS), lithium tetrafluoroborate (LiBF₄), lithium difluorophosphate (LiPO₂F₂), and 2-fluorobiphenyl (2-FBP).

In this case, the lithium nitrate may be contained in an amount of 0.01 to 0.1 wt %, and specifically, 0.03 to 0.07 wt %, with respect to the total weight of the electrolyte for a lithium metal battery.

### Lithium Metal Battery

A lithium metal battery may include a cathode, an anode, and an electrolyte located between the cathode and the anode, the cathode may include a cathode active material layer, the anode may include an anode active material layer, and the electrolyte may contain the first lithium salt, the second lithium salt, and the solvent described above.

When charged to 4.25 V and then discharged to 2.5 V are performed at 25° C. under 1 C-1 C conditions in one cycle, the lithium metal battery may have a capacity retention of 70% or more even after 120 cycles, and specifically, may have a capacity retention of 70% or more even after 125 cycles.

When charged to 4.25 V and then discharged to 2.5 V are performed at 25° C. under 1 C-1 C conditions in one cycle, even after 50 cycles, a molar ratio of the total lithium salts to the solvent in the lithium metal battery may be 1:1 to 1:10, and specifically, the molar ratio of the total lithium salts to the solvent in the lithium metal battery may be 1:1 to 1:5 or 1:1 to 1:3.

In the lithium metal battery, a lithium deposition layer disposed on the anode has a thickness of 40 μm or less, and specifically, 35 μm or less.

As described above, the lithium metal battery according to the present disclosure may have excellent ionic conductivity and improved durability, and excellent electrochemical properties. Consequently, it is well-suited for use in portable devices such as mobile phones, notebook computers, and digital cameras, and in the field of electric vehicles such as hybrid electric vehicles (HEVs).

Hereinafter, preferred Examples and Comparative Examples of the present disclosure will be described. However, each of the following Examples is merely a preferred example of the present disclosure, and the present disclosure is not limited to the following Examples.

### Examples and Comparative Examples

3.4 M FSA was used as a solvent, and an amount equivalent to 3 mol of FSA was first added to a container. Thereafter, a first lithium salt and a second lithium salt were added according to the materials and contents shown in Table 1, and the salts were dissolved by continuously stirring the mixture for 24 hours in a stirrer (@25° C.). At this time, it was confirmed that dissolution was completed by checking whether the salt became transparent. For reference, as shown in Table 1, in Comparative Examples 1, 5, and 6, only a single salt was added, not a complex salt, and in Example 2, additives were additionally added.

TABLE 1

| | First lithium salt | | Second lithium salt | | |
|---|---|---|---|---|---|
| | | Content | | Content | |
| | Material | [mole] | Material | [mole] | Additives |
| Example 1 | LiFSI | 0.7 | LiTFSI | 0.3 | — |
| Example 2 | LiFSI | 0.7 | LiTFSI | 0.3 | 0.05 wt % |
| | | | | | LiNO₃ + 1 |
| | | | | | wt % FEC + |
| | | | | | 1 wt % VC |
| Comparative | LiFSI | 1.0 | — | — | — |
| Example 1 | | | | | |
| Comparative | LiFSI | 0.6 | LiTFSI | 0.4 | — |
| Example 2 | | | | | |
| Comparative | LiFSI | 0.8 | LiTFSI | 0.2 | |
| Example 3 | | | | | |
| Comparative | LiFSI | 0.9 | LiTFSI | 0.1 | |
| Example 4 | | | | | |
| Comparative | LiFSI | 0.7 | — | — | |
| Example 5 | | | | | |
| Comparative | — | — | LiTFSI | 0.3 | |
| Example 6 | | | | | |
| Comparative | LiFSI | 0.7 | LiFTFSI | 0.3 | — |
| Example 7 | | | | | |
| Comparative | LiFSI | 0.6 | LiFTFSI | 0.4 | — |
| Example 8 | | | | | |
| Comparative | LiFSI | 0.9 | LiBETI | 0.1 | — |
| Example 9 | | | | | |
| Comparative | LiFSI | 0.9 | LiPF₆ | 0.1 | — |
| Example 10 | | | | | |
| Comparative | LiFSI | 0.8 | LiPF₆ | 0.2 | — |
| Example 11 | | | | | |

LiFTFSI, which is used as a type of secondary lithium salt in Table 1, is an abbreviation for lithium (fluorosulfonyl)(trifluoromethanesulfonyl)imide (CF₄LiNO₄S₂), and is represented by the following Chemical Formula 9, and LiBETI is an abbreviation for lithium bis(trifluoromethanesulfonyl)imide (CF₃SO₂NLiSO₂CF₃), and is represented by the following Chemical Formula 10. For reference, the lithium salts described in the present specification may be expressed by separating Li⁺ ions as shown in Chemical Formula 7.

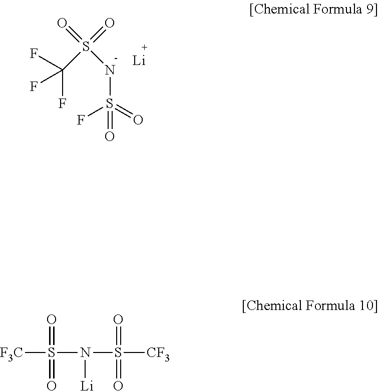

### Experimental Example 1: Analysis of Solvation Structure of Lithium Salt-Solvent in Electrolyte

The solvation structure of the lithium salt-solvent in the electrolyte was analyzed using Raman analysis.

The beneficial effects of the complex salt can be confirmed by analyzing the solvation structure within the electrolyte.

The experiment was performed using Horiba BX41 instrument with an excitation wavelength of 532 nm. The measurement conditions are as follows.
Exposure time: 100 seconds
Accumulated number of times: 10 times
Diffraction grating: 5 pieces/mm (nm)

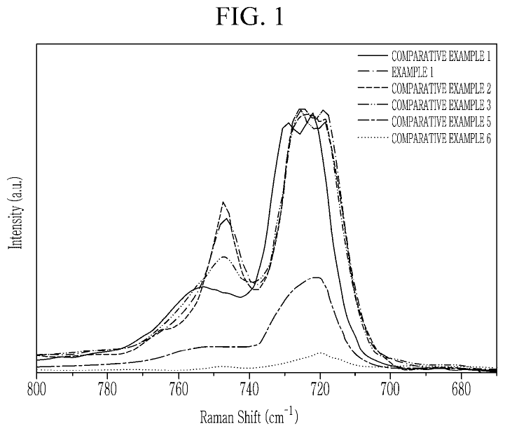

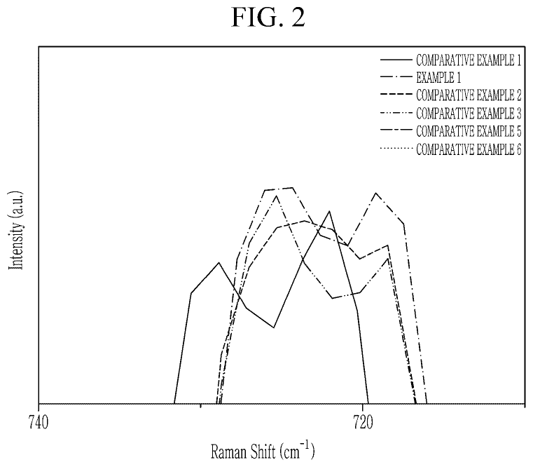

Among the Raman spectra of the entire measured region, curve fitting was performed on the spectrum from 670 cm⁻¹ to 800 cm⁻¹ to obtain the graph in FIG. 1. FIG. 2 is a graph obtained by confirming an enlarged portion of FIG. 1, specifically, an enlarged portion of a spectrum in a range of 710 cm⁻¹ to 740 cm⁻¹.

Referring to FIG. 1, in Example 1, compared to Comparative Example 1, it was confirmed that when the additional salt LiTFSI was added to LiFSI, the binding energy increased due to electronic interaction, resulting in a blue shift, and the graph moved in the negative direction (to the right in FIG. 1).

In addition, comparing Example 1 and Comparative Examples 2, 3, 5, and 6, as the content of LiTFSI increased, Li⁺ coordinated FSI decreased as confirmed at 757±2 cm⁻¹, and Li⁺ coordinated TFSI increased as confirmed at 749±2 cm⁻¹.

In addition, referring to FIGS. 1 and 2, as confirmed at 728±2 cm⁻¹, the number of aggregations (AGGs) and contact ion pairs (CIPs) of Example 1 were greater than those in Comparative Example 1, and as confirmed at 746±2 cm⁻¹, the interaction between FSI⁻/TFSI⁻ and Li⁺ increased. This indicates a durability improvement through the formation of anion-derived SEI. Specifically, the formation of a stable SEI is attributed to changes in the solvation structure, shifting from a solvent-separated ion pair (SSIP) to an aggregation (AGG) and contact ion pair (CIP) structure as the lithium salt content increases.

As a result, considering the above improvement effects, it was confirmed that the electrolyte of Example 1 had a composition that exhibited the best durability when applied to a lithium metal battery.

### Experimental Example 2: Evaluation of Reversibility of Lithium Using Cu-NMC

### (Anodeless Cell)

The reversibility of lithium according to the electrolyte of each of Example 1 and Comparative Example 1 was quantitatively evaluated by charging and discharging the cell only with lithium of the cathode (LiNi_{0.80}Co_{0.10}Mn_{0.10}O₂, NCM811). Since the electrolyte was prepared with the molecular number ratio of the first lithium salt LiFSI and the solvent FSA, it was possible to approach from the perspective of the solvation structure in the electrolyte molecule.

Specifically, in the evaluation of the reversibility of lithium, a Cu foil without lithium was used on the anode, and only lithium on the cathode was used during charging and discharging. As a result, it was possible to quantitatively confirm the reversible amount of lithium used through the tendency of the discharge capacity to decrease during charging and discharging.

The charging and discharging conditions are 1/3 C-1/3 C, and specifically as follows.

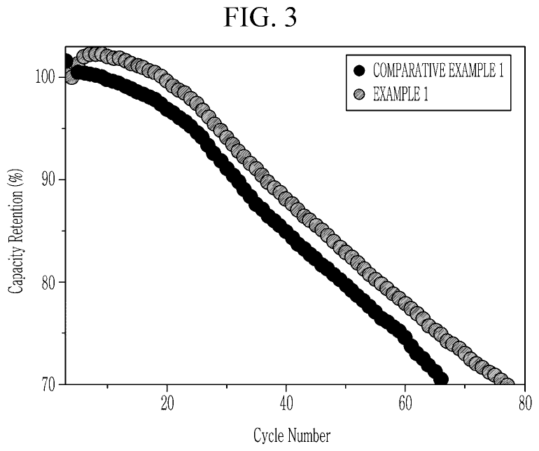

Charging to 4.25 V and then discharging to 2.5 V were performed at 25° C. under 0.33 C/0.33C conditions in one cycle, in all of the charge and discharge cycles, the capacity retention measured with a 20-minute pause after one charge and discharge cycle was calculated and illustrated in FIG. 3.

Referring to FIG. 3, when compared to Comparative Example 1 in which a single salt electrolyte was used, it was confirmed that the complex salt electrolyte as in Example 1 showed high reversibility during charging and discharging. Specifically, as for the cycle where the capacity retention was 70%, Comparative Example 1 showed about 67 cycles, and Example 1 showed about 78 cycles.

It is confirmed that, as oxidation stability increases due to a decrease in the deterioration factor (free solvent) and the amount of lithium charge transfer (Li⁺ transfer) increases, lithium is uniformly deposited, and thus, the effect contributes to the reversibility of lithium.

### Experimental Example 3: Evaluation of Electrochemical Properties of Lithium Metal Battery

A lithium metal battery was manufactured using the electrolyte prepared in each of Examples and Comparative Examples. LiNi_{0.80}Co_{0.10}Mn_{0.10}O₂ (NCM811) was used as a cathode, and a thin film of lithium having a thickness of 20 to 50 μm was used as an anode to manufacture a battery in the form of a coin cell. A separator whose top and bottom were coated with 20 um of ceramic was used, and the electrolyte prepared in each of Examples and Comparative Examples was used as a liquid electrolyte.

The following experiments were performed using the lithium metal batteries manufactured as described above.

### (1) Evaluation of Durability of Lithium Metal Battery

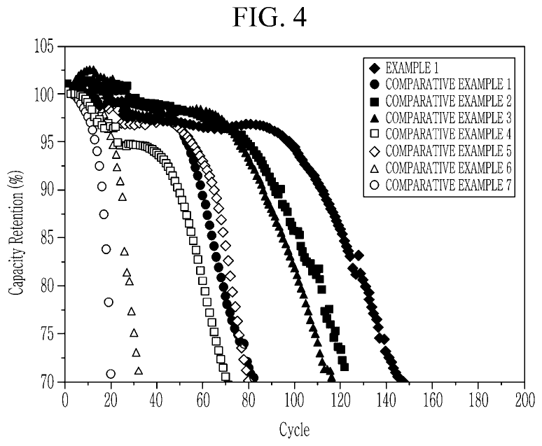

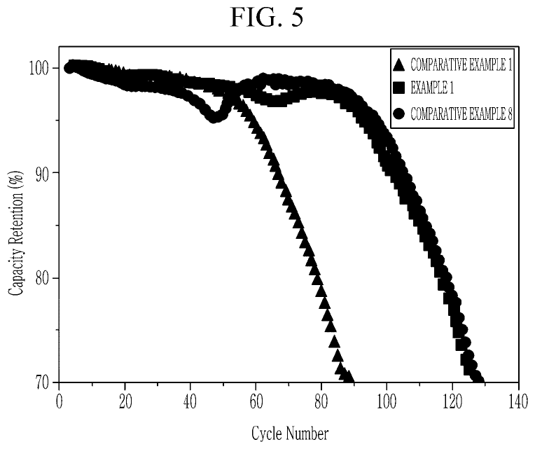

Other salts were added to the existing LiFSI salt and the optimal composition was confirmed through Li/NMC 1C durability evaluation of the complex salt. For a lithium metal battery containing the electrolyte of each of Examples or Comparative Examples, charging to 4.25 V and then discharging to 2.5 V were performed at 25° C. under 1 C-1 C conditions in one cycle, and in all of the charge and discharge cycles, charging and discharging were performed with a 20-minute pause after one charge and discharge cycle. As a result, the durability lifespan was measured, and the capacity retention was calculated. The results are shown in the graphs in FIGS. 4 and 5. That is, through the evaluation of the durability of the lithium metal battery, it was possible to evaluate the characteristics of the complex salt.

When comparing Example 1 and Comparative Example 7 in FIG. 4, it can be seen that the complex salt electrolyte composition prepared by adding LiTFSI as an additional salt shows better durability than LiFTFSI. In addition, it was confirmed that the durability was improved in Example 1 and Comparative Examples 2 and 3 in which a complex salt electrolyte was used, compared to Comparative Example 1 in which a single salt electrolyte was used. In particular, the electrolyte having the composition of Example 1 showed the best durability.

FIG. 5 illustrates improved lithium metal battery lifespan in a lithium metal battery containing the electrolyte of Example 1 compared to Comparative Example 1. In the Li/NMC 1 C evaluation, in the cycle where the capacity retention was 70%, it was confirmed that the lifespan was improved by 37% in Example 1 and by 41% in Example 2 in which an additive was added, compared to Comparative Example 1.

As a result, it was confirmed that the complex salt enhanced ionic conductivity and the additives formed an anode film, thereby improving durability.

### (2) Analysis of Amount of Electrolyte Consumed Using Nuclear Magnetic Resonance Spectroscopy (NMR)

The amount of electrolyte components consumed was quantitatively analyzed through NMR analysis of the electrolyte. For each coin cell manufactured in the manner described above, a case of 0 cycles (before charging and discharging), and a case in which charging to 4.25 V and then discharging to 2.5 V were performed at 25° C. under 1/3 C-1/3 C conditions in one cycle, and in all of the charge and discharge cycles, 10 cycles, 30 cycle, 50 cycles, 100 cycles, and 150 cycles of the charging and discharging were performed with a 20-minute pause after one charge and discharge cycle, were disassembled and analyzed. The device used at this time was AVANCEIII 700 NMR, and the measurement condition was 700 Hz.

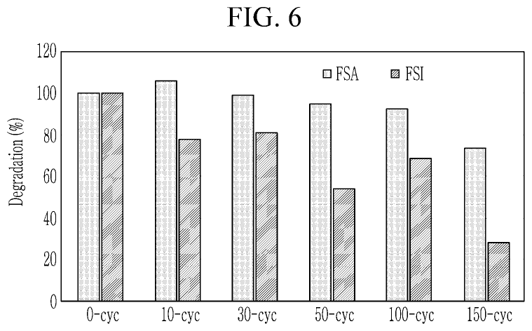

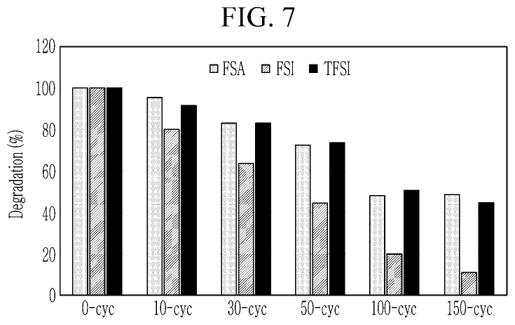

FIG. 6 illustrates the amounts of solvent FSA and first lithium salt LiFSI consumed (a unit of mole) in Comparative Example 1 using the existing FSA solvent-based single salt electrolyte, and FIG. 7 illustrates the amounts of solvent FSA, first lithium salt LiFSI, and second lithium salt LiTFSI consumed (a unit of mole) in Example 1 using an electrolyte incorporating LiTFSI salt as a complex salt.

Referring to FIGS. 6 and 7, it is confirmed that, during the cycle, the existing FSA solvent-based single salt electrolyte predominantly undergoes oxidative degradation of LiFSI salt at the cathode, along with reductive degradation of LiFSI and the FSA solvent at the anode, adversely affecting the durability. On the other hand, it was confirmed that durability improved by supplementing ionic conductivity by introducing LiTFSI salt as a complex salt.

### (3) Scanning Electron Microscope (SEM) Image Analysis

In the lithium metal battery containing the electrolyte of each of Examples or Comparative Examples, image measurement was performed under 15 kV acceleration voltage conditions, and then SEM images of the top and side of the current collector were obtained. Through this, the deposition shape, and the thickness and uniformity of the SEI layer were confirmed.

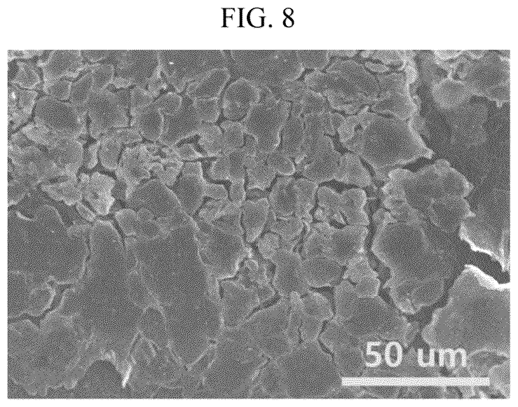

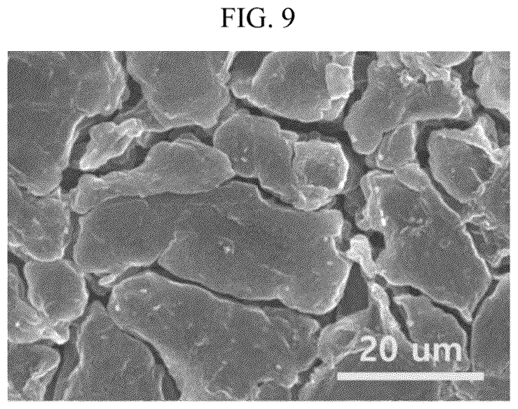

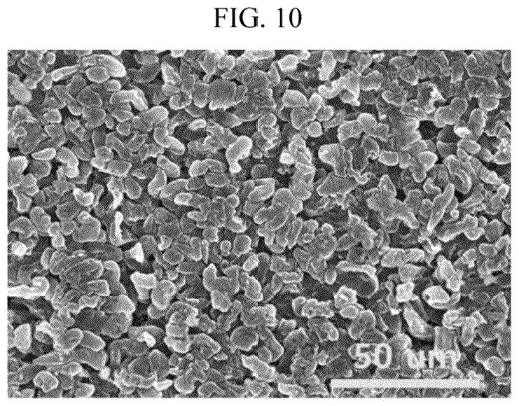

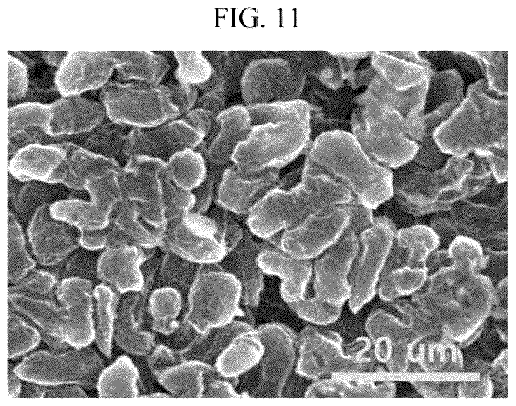

FIG. 8 is an SEM image magnified 1,000 times of the top of the current collector when using the electrolyte of Example 1, FIG. 9 is an SEM image magnified 2,500 times of the top of the current collector when using the electrolyte of Example 1, FIG. 10 is an SEM image magnified 1,000 times of the top of the current collector when using the electrolyte of Comparative Example 1, and FIG. 11 is an SEM image magnified 2,500 times of the top of the current collector when using the electrolyte of Comparative Example 1.

Referring to FIGS. 8 to 11, when the electrolyte of Example 1 was used, it was confirmed that the particle size was larger than that of Comparative Example 1. Through this, dead Li may be minimized during stripping, and the small surface area may enable uniform distribution of the current, thereby lowering the current density. When lithium is deposited in the subsequent cycle, lithium is induced to be deposited densely and uniformly, such that side reactions between lithium and the electrolyte may be reduced.

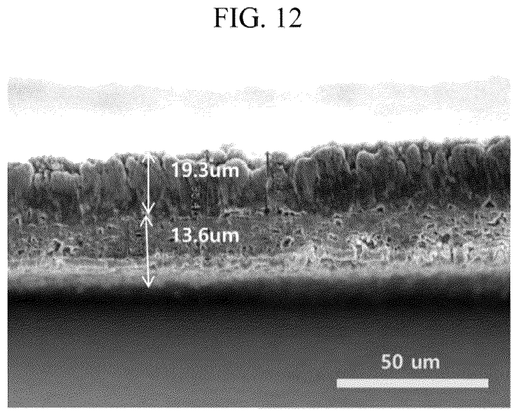

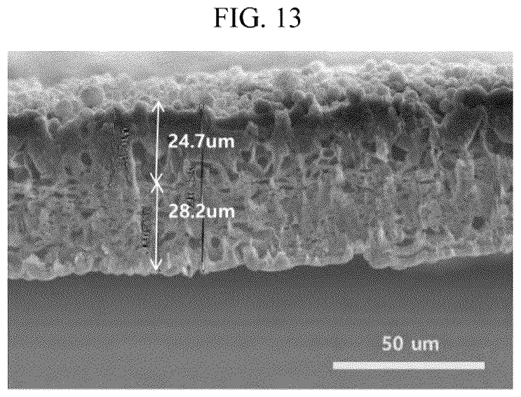

FIG. 12 is an SEM image magnified 1,000 times of the side of the current collector when using the electrolyte of Example 1, and FIG. 13 is an SEM image magnified 1,000 times of the side of the current collector when using the electrolyte of Comparative Example 1.

Referring to FIGS. 12 and 13, when the electrolyte of Example 1 was used, it was confirmed that the thickness of the deposition layer decreased compared to Comparative Example 1. Through this approach, it is expected that the formation of the SEI layer will induce uniform deposition, leading to consistent performance throughout subsequent cycles

### (4) Output Evaluation (Rate Performance)

The output of the coin cell containing the electrolyte of each of Example 1 and Comparative Example 1 was evaluated. The coin cell was charged with CC-CV to 4.25 V at a constant current of 0.33 C at 25° C. Thereafter, the coin cell was discharged to 3 V at constant currents of 0.33 C, 1 C, and 2 C. The charging and discharging behavior was set to 5 cycles, and a 10-minute pause was provided after one charge and discharge cycle in all of the charge and discharge cycles.

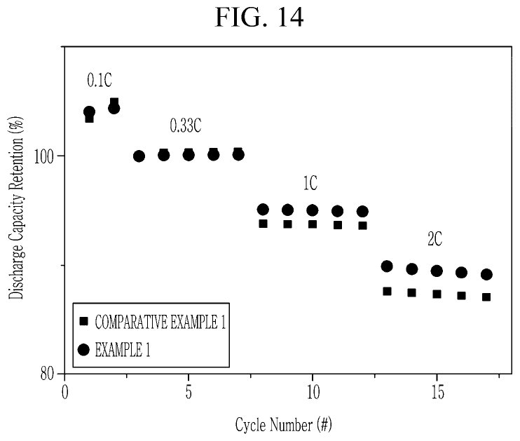

After repeating the cycle 5 times, the discharge capacity retention according to the cycle was measured. At this time, the discharge capacity retention at 0.33 C was set to 100%, and a discharge capacity retention was calculated based on the set discharge capacity retention. As a result, the results as illustrated in FIG. 14 were obtained and were summarized in Table 2.

TABLE 2
Discharge capacity retention (%) compared to at 0.33 C

| | Comparative Example 1 | Example 1 |
|---|---|---|
| 1 C | 93.82 | 95.12 |
| 2 C | 87.63 | 89.91 |

Referring to FIG. 14 and Table 2, it is evident that improved characteristics are exhibited at a high rate of 1 C or higher compared to the existing reference. Specifically, at 1 C and 2 C, compared to Comparative Example 1, Example 1 shows a capacity retention that is more than 2% better, while also exhibiting superior output characteristics.

Therefore, through comparison with Comparative Examples in the results of the experiments, it may be confirmed that the lithium metal battery containing the electrolyte of each of Examples 1 and 2 is electrochemically excellent.

The present disclosure is not limited to the exemplary embodiments, but may be prepared in various different forms, and it will be apparent to those skilled in the art to which the present disclosure pertains that the exemplary embodiments may be implemented in other specific forms without departing from the spirit or essential feature of the present disclosure. Therefore, it is to be understood that the exemplary embodiments described hereinabove are illustrative rather than restrictive in all aspects.

What is claimed is:

1. An electrolyte for a lithium metal battery, the electrolyte comprising:
a first lithium salt containing a fluorosulfonyl group represented by Chemical Formula 1;
a second lithium salt containing a trifluoromethanesulfonyl group represented by Chemical Formula 2; and
a solvent containing a fluorosulfonyl group represented by Chemical Formula 1,
wherein a molar ratio of the first lithium salt to the second lithium salt is 0.65:0.35 to 0.75:0.25:

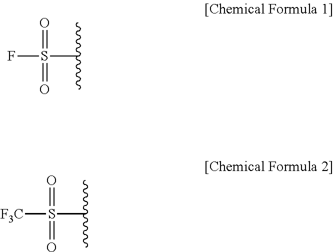 [SMILES: *S(=O)(=O)F ; *S(=O)(=O)C(F)(F)F]

2. The electrolyte of claim 1, wherein:
the first lithium salt comprises a first lithium salt represented by Chemical Formula 3,
the second lithium salt comprises a second lithium salt represented by Chemical Formula 4,
the solvent comprises a solvent represented by Chemical Formula 5, and
a molar ratio of the first lithium salt to the second lithium salt is 0.65:0.35 to 0.75:0.25, 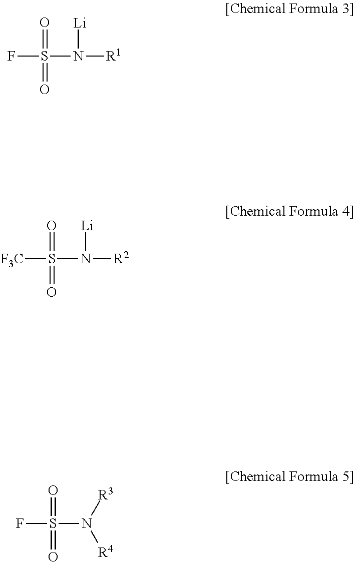
wherein R¹ and R² are substituted with one functional group selected from the group consisting of 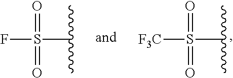 [SMILES: *S(=O)(=O)F ; *S(=O)(=O)C(F)(F)F]
and
R³ and R⁴ are each independently substituted with one functional group selected from the group consisting of hydrogen and an unsubstituted C1-10 alkyl group.

3. The electrolyte of claim 1, wherein:
the first lithium salt containing a fluorosulfonyl group and the solvent containing a fluorosulfonyl group do not contain a trifluoromethanesulfonyl group.

4. The electrolyte of claim 1, wherein:
the second lithium salt containing a trifluoromethanesulfonyl group does not contain a fluorosulfonyl group.

5. The electrolyte of claim 1, wherein:
a molar ratio of the solvent to a complex salt comprising the first lithium salt and the second lithium salt is 1:1 to 1:10.

6. The electrolyte of claim 5, wherein:
the molar ratio of the solvent to the complex salt comprising the first lithium salt and the second lithium salt is 1:3.

7. The electrolyte of claim 1, wherein:
the first lithium salt is a lithium salt represented by Chemical Formula 6:

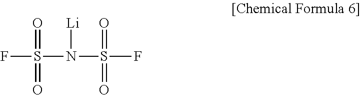

8. The electrolyte of claim 1, wherein:
the second lithium salt is a lithium salt represented by Chemical Formula 7:

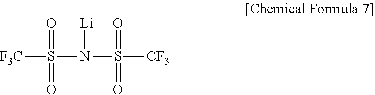

9. The electrolyte of claim 1, wherein:
the solvent is a solvent represented by Chemical Formula 8:

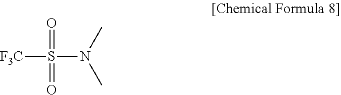

10. The electrolyte of claim 1, further comprising:
one or more additives selected from lithium nitrate (LiNO3), vinylene carbonate (VC), fluoroethylene carbonate (FEC), difluoroethylene carbonate, chloroethylene carbonate, dichloroethylene carbonate, bromoethylene carbonate, dibromoethylene carbonate, nitroethylene carbonate, cyanoethylene carbonate, vinylethylene carbonate (VEC), adiponitrile (AN), succinonitrile (SN), 1,3,6-hexane tricyanide (HTCN), propene sultone (PST), propane sultone (PS), lithium tetrafluoroborate (LiBF4), lithium difluorophosphate (LiPO2F2), and 2-fluorobiphenyl (2-FBP).

11. The electrolyte of claim 10, wherein:
the lithium nitrate is contained in an amount of 0.01 to 0.1 wt % with respect to a total weight of the electrolyte for a lithium metal battery.

12. The electrolyte of claim 1, wherein the molar ratio of the first lithium salt to the second lithium salt is 0.7:0.3.

13. The electrolyte of claim 12, wherein:
a molar ratio of the solvent to a complex salt comprising the first lithium salt and the second lithium salt is 1:1 to 1:10.

14. The electrolyte of claim 13, wherein:
the molar ratio of the solvent to the complex salt comprising the first lithium salt and the second lithium salt is 1:3.

15. A lithium metal battery comprising:
a cathode; an anode; and an electrolyte located between the cathode and the anode,
wherein the electrolyte is the electrolyte for a lithium metal battery of claim 1.

16. The lithium metal battery of claim 15, wherein:
when charged to 4.25 V and then discharged to 2.5 V at 25° C. under 1 C-1 C conditions in one cycle, the lithium metal battery has a capacity retention of 70% or more after 120 cycles.

17. The lithium metal battery of claim 15, wherein:
when charged to 4.25 V and then discharged to 2.5 V at 25° C. under 1/3 C-1/3 C conditions in one cycle, a molar ratio of the total lithium salts to the solvent in the lithium metal battery is 1:1 to 1:10 after 50 cycles.

18. The lithium metal battery of claim 15, wherein:
in the lithium metal battery, a lithium deposition layer disposed on the anode has a thickness of 40 μm or less.

19. A battery comprising the electrolyte of claim 1.

20. A battery comprising the lithium metal battery of claim 15.
